(19) United States
(12) Patent Application Publication
(10) Pub. No.: US 2022/0100263 A1
(43) Pub. Date: Mar. 31, 2022

(54) VISUALIZING AUTOMATION CAPABILITIES THROUGH AUGMENTED REALITY

(71) Applicant: International Business Machines Corporation, Armonk, NY (US)

(72) Inventors: Raghuveer Prasad Nagar, Kota (IN); Sarbajit K. Rakshit, Kolkata (IN); Jagadesh Ramaswamy Hulugundi, Bangalore (IN); Reji Jose, Bangalore (IN)

(21) Appl. No.: 17/038,407

(22) Filed: Sep. 30, 2020

(51) Int. Cl. G06F 3/01; G05D 1/00; G02B 27/01; G06T 19/00

(52) U.S. Cl. CPC G06F 3/011; G06F 3/017; G05D 1/0038; G02B 2027/0178; G02B 27/0172; G06T 19/006; G05D 1/0016

(57) ABSTRACT

Techniques for leveraging augmented reality devices to provide enhanced observation and control of automation devices performing automation functions. Augmented reality devices receive information from local sensors concerning the performance of local automation devices. This information is used to generate graphical representations of said performance upon the physical environment where the automation devices perform their respective automation tasks as viewed from the perspective of a user wearing the augmented reality devices. The graphical representations provide an intuitive interface for observing the performance of automation tasks and automation capabilities within a physical environment. In some embodiments, gesture-based input is received by the augmented reality devices to interact with the graphical representation to modify the performance of the automation devices performing automation tasks.

### BACKGROUND

The present invention relates generally to the field of augmented reality devices, and more particularly to automation management using augmented reality devices.

Augmented reality (AR) systems refer to interactive experiences with a real-world environment where objects which reside in the real world are modified by computer-generated perceptual information, sometimes across two or more sensory modalities, including visual, auditory, haptic, somatosensory and olfactory. AR systems are frequently defined to require three basic features: a combination of real and virtual worlds, real-time interaction, and accurate 3D registration of virtual and real objects. The overlaid sensory information typically comes in two varieties. The first variety is constructive (i.e. additive to the natural environment), and the second variety is destructive (i.e. masking of the natural environment). This experience is smoothly interwoven with the physical world in such a way that it is frequently perceived as an immersive aspect of the real environment. In this way, AR alters a person's ongoing perception of a real-world environment, as contrasted to virtual reality which fully replaces the user's real-world environment with a simulated one. AR is related to two terms which are largely synonymous: mixed reality and computer-mediated reality. With the help of advanced AR technologies (e.g. incorporating computer vision, leveraging AR cameras into smartphone applications and object recognition) information about the surrounding real world of the AR user becomes interactive and digitally manipulated. Information about the environment and objects within it is overlaid onto the real world.

The Internet of things (IoT) is a system of interrelated computing devices, mechanical and digital machines provided with unique identifiers (UIDs) and the capability to transfer information over a network without requiring human-to-human or human-to-computer interaction. The definition of the Internet of things has evolved over time due to the convergence of multiple technologies such as real-time analytics, commodity sensors, machine learning, and embedded systems. Traditional fields of embedded systems such as wireless sensor networks, control systems, automation (including home and building automation), and others all contribute to facilitating the Internet of things.

Computer vision is an interdisciplinary field which grapples with how computers can be granted the ability to gain high-level understanding from digital images or videos. From an engineering perspective, it seeks to automate tasks that the human visual system can do. Computer vision related to the automatic extraction, analysis and understanding of useful information from a single image or a sequence of images such as an animation or video feed. It involves developing a theoretical and algorithmic basis to achieve automatic visual understanding.

### SUMMARY

According to an aspect of the present invention, there is a method, computer program product and/or system that performs the following operations (not necessarily in the following order): (i) receiving an automation data set including information indicative of automation capability coverage in a physical space for at least one automation device; (ii) generating a graphical representation of the automation capability coverage based, at least in part, on the automation data set; (iii) displaying, on a display of an augmented reality (AR) device, the graphical representation as an overlay upon the physical space as viewed through the AR device.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4A is a first screenshot view generated by the first embodiment system;

FIG. 4B is a second screenshot view generated by the first embodiment system;

FIG. 5 is a first screenshot view generated by a second embodiment system; and

FIG. 6 is a second screenshot view generated by the second embodiment system.

### DETAILED DESCRIPTION

Some embodiments of the present invention are directed to techniques for leveraging augmented reality devices to provide enhanced observation and control of automation devices performing automation functions. Augmented reality devices receive information from local sensors concerning the performance of local automation devices. This information is used to generate graphical representations of said performance upon the physical environment where the automation devices perform their respective automation tasks as viewed from the perspective of a user wearing the augmented reality devices. The graphical representations provide an intuitive interface for observing the performance of automation tasks and automation capabilities within a physical environment. In some embodiments, gesture-based input is received by the augmented reality devices to interact with the graphical representation to modify the performance of the automation devices performing automation tasks.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium, sometimes referred to as machine readable storage device, can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

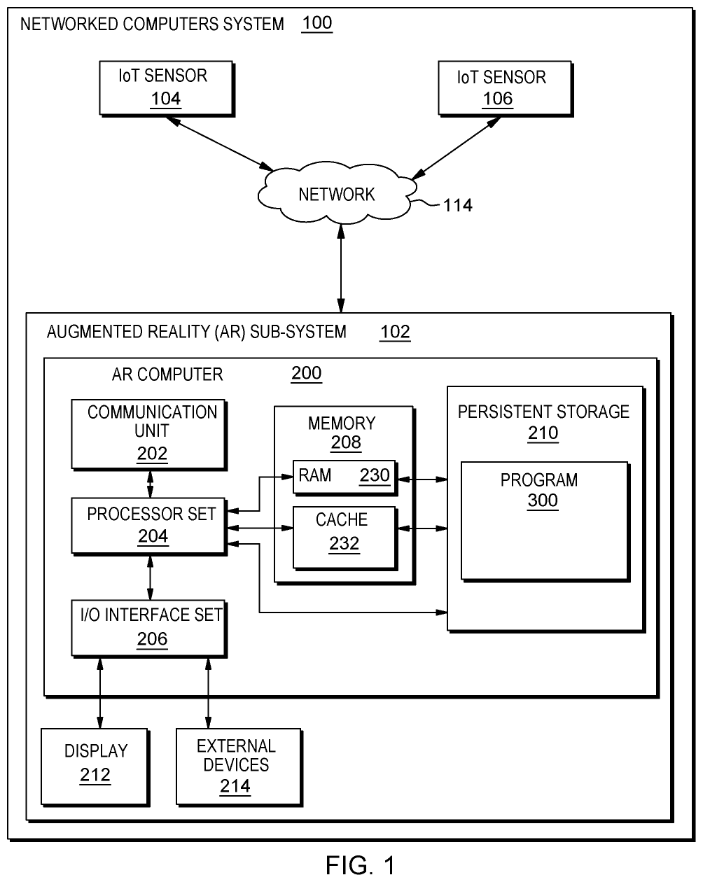

As shown in FIG. 1, networked computers system 100 is an embodiment of a hardware and software environment for use with various embodiments of the present invention. Networked computers system 100 includes: augmented reality (AR) subsystem 102 (sometimes herein referred to, more simply, as subsystem 102); internet of things (IoT) sensors 104 and 106; and communication network 114. AR subsystem 102 includes: AR computer 200; communication unit 202; processor set 204; input/output (I/O) interface set 206; memory 208; persistent storage 210; display 212; external device(s) 214; camera 216; GPS module 218; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Camera 216 can include any type of optical sensor capable of receiving and processing electromagnetic spectra, including visible electromagnetic information, infrared, ultraviolet, x-ray, microwave, radio and gamma.

GPS module 218 can include any type of GPS module capable of transmitting and/or receiving GPS positioning information, such as a GPS transceiver.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

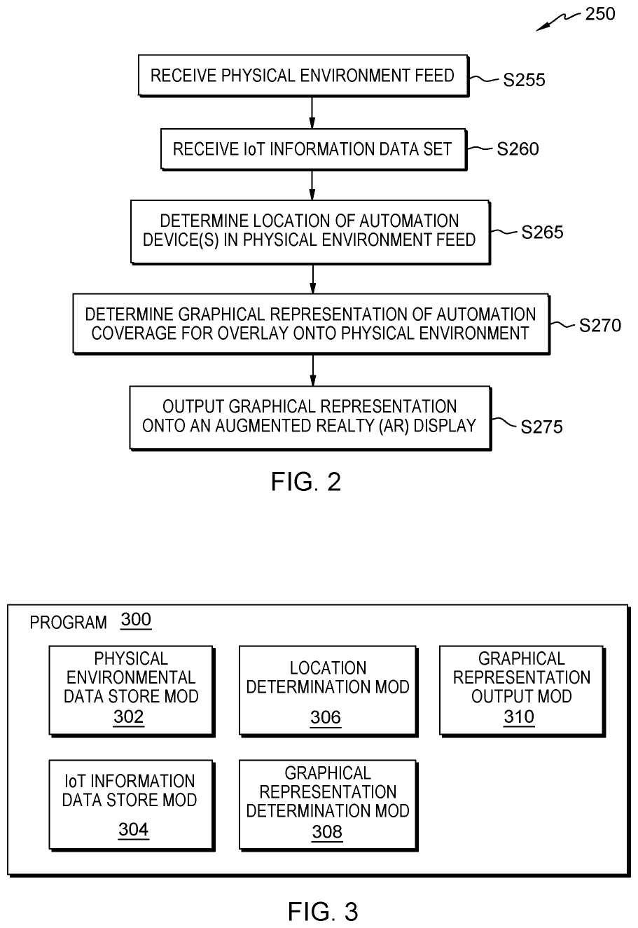

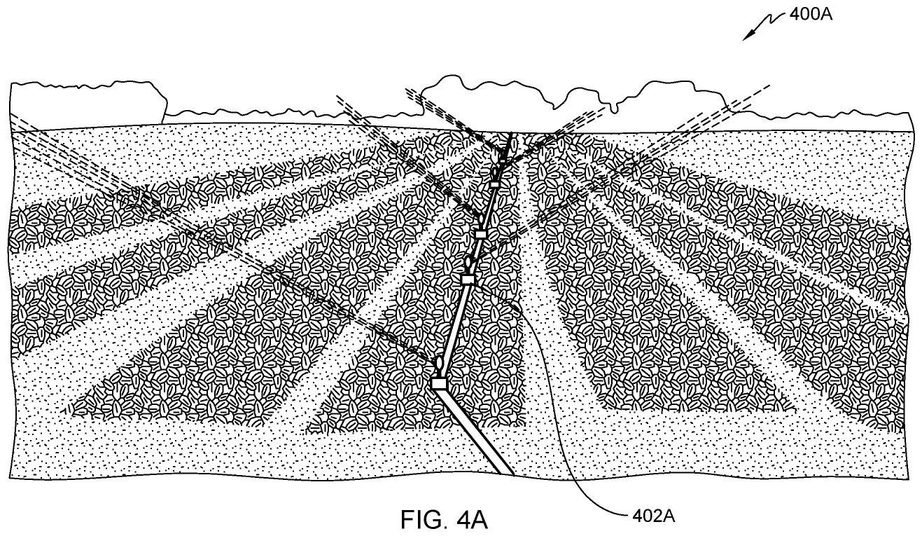

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

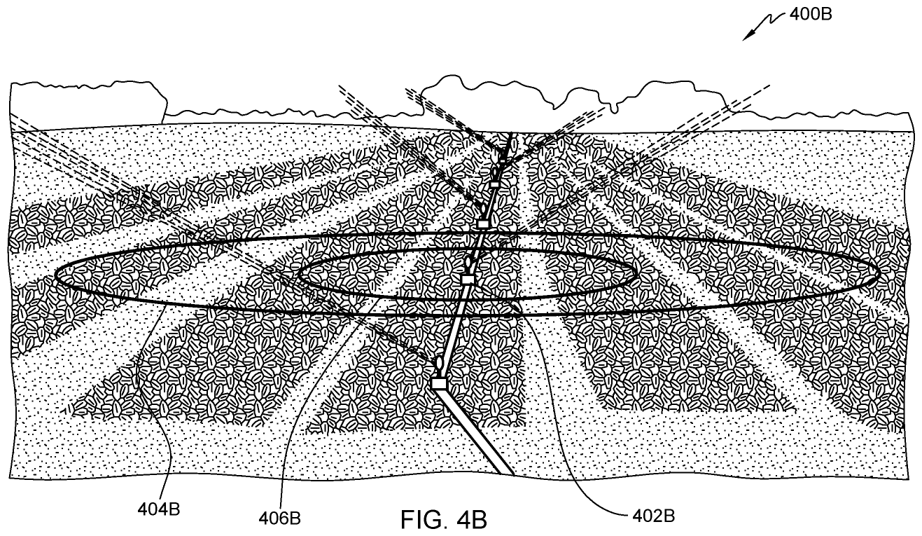

Processing begins at operation S255, where physical environment data store module (“mod”) 302 receives a physical environmental feed. In this simplified embodiment, the physical environmental feed is a stream of video data of a plot of farmland, from the perspective of a user's head, received from camera 216 of FIG. 1, shown in screenshot 400A of FIG. 4A, where AR sub-system 102 is an eyeglass-type of wearable AR device. Shown in screenshot 400A is IoT enabled water sprinkler 402A (sometimes referred to as water sprinkler 402A), which includes IoT sensor 104 of FIG. 1. Water sprinkler 402A provides automation capabilities for automatically watering crops and soil in a defined radius centered on water sprinkler 402A. In alternative embodiments, the video feed may include other physical environments or other objects present in the environment, including other communication-enabled sensors and/or automation devices. In other alternative embodiments, the physical environmental feed includes other types of optical information, such as an infrared camera feed, ultraviolet camera feed, or other types of electromagnetic spectra recorded by an optical sensor and/or camera. The infrared, ultraviolet, or other electromagnetic spectra may be replacements for or supplemental to a recorded feed of visible light. For example, a video feed of visible light may be recorded simultaneously alongside another video feed of infrared light. In alternative embodiments, other types of wearable AR devices are used, such as a head mounted display (HMD), heads up display, contact lens display, virtual retinal display (VRD), or an EyeTap device.

Processing proceeds to operation S260, where internet of things (IoT) information data store mod 304 receives an IoT information data set. In this simplified embodiment, the IoT information data set includes the location of the IoT enabled water sprinkler 402A, the instructed output of the IoT enabled water sprinkler as a watering radius measured in meters, and the present output of the IoT enabled water sprinkler as a watering radius measured in meters. In this simplified embodiment, IoT sensor 104 of FIG. 1 communicates GPS coordinates for water sprinkler 402A (water sprinkler coordinates), as well as the instructed output of water sprinkler 402A, 10 meters, and the present output of 5 meters. The instructed output is a level of output desired by the operating user of water sprinkler 402A. In alternative embodiments, different types of information is included in the information data set, including the type of output or automation capabilities, schedules for an automation device, operating status of an automation device, permission levels required to interact with the automation device, historical performance records of the automation device, maximum and/or minimum automation capability output information of the automation device, etc. For example, permission levels can indicate whether a given user is permitted to access, operate and/or adjust a given automation device, and lacking the appropriate permission level may restrict the given user from some or all of the above actions, such as viewing or accessing the given automation device may be permitted but adjusting parameters of the given automation device may be restricted.

Processing proceeds to operation S265, where location determination mod 306 determines the location of automation device(s) in the physical environment feed. In this simplified embodiment, determining the location of the automation device(s) includes determining the location of water sprinkler 402A in the physical environment feed as well as circumferences of circles corresponding to the watering radii for the instructed output and the present output, centered on the IoT enabled water sprinkler and aligned to the ground. In this simplified embodiment, the location of water sprinkler 402A in the physical environment feed is determined by using GPS coordinates of sub-system 102 of FIG. 1, as determined by GPS module 218, and the GPS coordinates of water sprinkler 402A received at S260, to provide relative positioning and determine the distance between water sprinkler 402A and sub-system 102. With relative positioning determined, accelerometers and magnetic field sensors (embedded in AR sub-system 102 as part of external devices 214) are used to determine if AR sub-system 102 (and therefore, the user wearing AR sub-system 102) is facing water sprinkler 402A. Computer vision techniques are then applied to the physical environment feed to further refine the location of water sprinkler 402A using the distance as guidance. In alternative embodiments, wireless signals emitted from water sprinkler 402A are received by AR sub-system 102 and another receiver and used to triangulate the position of water sprinkler 402A relative to AR sub-system 102. In further alternative embodiments, locations can be determined by geofencing techniques.

Processing proceeds to operation S270, where graphical representation determination mod 308 determines a graphical representation of automation coverage for overlay onto the physical environment. In this simplified embodiment, determining the graphical representation of automation coverage includes determining a semi-transparent gray colored circle, centered on water sprinkler 402A, corresponding to the watering radius of the instructed output, and a semi-transparent red colored circle, centered on water sprinkler 402A, corresponding to the watering radius of the present output. Computer vision techniques applied to the physical environment feed are used to determine the boundaries of a circle corresponding to the watering radius of the instructed output and aligned to the plane of the ground, translated based on the perspective of AR sub-system 102 when viewing the physical environment in the physical environment feed, resulting in a first transformed circle. This process is repeated again for the watering radius of the present output, resulting in boundaries for a second circle, residing within the previous circle, and again translated from the perspective of AR sub-system 102 resulting in the second transformed circle. The second transformed circle is projected upon the first transformed circle and placed over the appropriate location in the physical environment feed, resulting in the graphical representation of automation coverage.

Processing proceeds to operation S275, where graphical representation output mod 310 outputs the graphical representation onto an AR display. In this simplified embodiment, the graphical representation is outputted to the AR display, display 212, by overlaying, from the perspective of the user, the larger gray colored circle centered over the IoT enabled water sprinkler, as shown in screenshot 400B of FIG. 4B, now showing water sprinkler 402A as water sprinkler 402B, with first transformed circle 404B and second transformed circle 406B. In alternative embodiments, gesture controls can be used to interact with the graphical representation, corresponding to modifications of water sprinkler 404A/404B. In other alternative embodiments, different types of automation devices are present in different physical environment feeds.

### III. Further Comments and/or Embodiments

Some embodiments of the present invention recognize the following facts, potential problems and/or potential areas for improvement with respect to the current state of the art: (i) in any IoT sensor network, there can be multiple sensors spread across an area; (ii) different sensors are capturing different types of data, and when different types of IoT feeds are analyzed, different types of analysis outcomes and decision/automation can be implemented; (iii) when different IoT sensor feeds are analyzed, various analysis and outcomes can be achieved; (iv) for example, controlling fire sprinklers when smoke is detected, or controlling sprinklers in a cultivation field when moisture levels are low; (v) these one or more automation capabilities can be achieved based on IoT feed analysis; (vi) with existing methods, it is not possible to visualize automation capabilities in any physical environment; (vii) IoT feed based automation capability ranges can be identified, but visualizing the ranges over the same physical environment is not possible.

Some embodiments of the present invention may include one, or more, of the following operations, features, characteristics and/or advantages: (i) disclosed is an AI and IoT based system and method to help a user visualize IoT-based-automation capabilities in any physical environment with augmented reality glass; (ii) to help the user understand what types of automation is active in a given environment; (iii) highlight the areas which requires correction of the determined problems through visual analysis and learning; (iv) generate machine-learning-based recommendations on corrective actions based on user privileges; (v) also apply/deploy the corrective actions; (vi) capabilities of automation can be reduced from various events/causes (for example, a sprinkler which can spray within a 10 meter radius is now limited to spraying water within a 7 meter radius because the capability of the providing pump has been reduced) in different contextual situation, so the impacted boundary can also be visualized with augmented reality glass; (vii) IoT feed from any physical surrounding will be analyzed to identify all possible automation capability coverages area in the visible physical surrounding; (viii) accordingly, when the user looks at that physical environment with augmented reality glass, then the said automation capabilities will be overlaid over the “Field of View” of the user, exactly mapped to the viewable physical environment; (ix) for example, in a cultivation field, there are various IoT sensors are installed; (x) based on the IoT sensor feed, the automation system will perform various activities in the physical surrounding, like: (a) watering the cultivation field, (b) applying pesticides with drone, (c) de-weeding activities etc.; and (xi) when a user looks at the cultivation field with augmented reality glass, the user can visualize what types of automation can be performed in the surrounding and the same will exactly be overlaid over the viewable physical area.

Some embodiments of the present invention may include one, or more, of the following operations, features, characteristics and/or advantages: (i) based on the IoT feed analysis, the augmented reality system will be showing strength of the automation capabilities in the physical surrounding; (ii) also enabling views where automation capability is poor or not activated in the physical surrounding, which can be controlled by the user based on the privileges/roles of the user; (iii) for example, a user can use augmented reality glass and visualize which area of the cultivation field is having problem with automatic watering when the area is highlighted; (iv) in another example, only a store manager will be able to take decision on redeployment of store representatives or robots; (v) augmented reality system will be showing impacted area in any environment because of reduction or change in automation capabilities, and accordingly the user can visualize the physical environment which will be impacted; (vi) for example, capability of automation can be reduced (like a sprinkler can spray within 10 meter radius boundary, but the output capability of a corresponding pump has been reduced so, limiting the sprinkler's output to a 7 meter radius boundary) in different contextual situation, so the impacted boundary can also be visualized with augmented reality glass; (vii) if multiple automation capabilities are possible in different time-frames and change in contextual situation, then augmented reality glass will be showing the time scale, and contextual situation, so that user can view the automation capabilities in the time scale; and (viii) for example, if multiple automation capabilities are present in the area, and those are triggered based on time or event-based scheduling, the augmented reality system can display the overlaid automation capabilities in the surrounding.

Some embodiments of the present invention may include one, or more, of the following operations, features, characteristics and/or advantages: (i) if any automation capability propagates from one physical location to another physical location based on the time or event-based parameter, then the augmented reality system can overlay the same in the “field of view” with animated propagation of the automation capabilities based on time or event-based criteria; (ii) for example, if the automation capability is started at a corner of a cultivation field, and then moves to other corner gradually, then the augmented reality system will be showing how the same is propagating from one corner to another corner with animated overlays; (iii) while interacting with augmented reality glass, a user can interact with the graphical augmented reality capabilities in the surrounding and change the propagation path of automation flow with hand or finger gestures; (iv) for example, using augmented reality glass, the automation capabilities will be overlaying over the “field of view” of the user, so user can change the propagation path of automation propagation in the augmented reality glass; (v) using AR based visualization, the proposed system highlights maintenance requirement areas and, with impact analysis, any device that is having problems is highlighted in the AR system; (vi) for example, if one water sprinkler is not working or having problems, the AR system shows which areas of the field not have water sprayed by the sprinkler; (vii) based on above determination, the system recommends which personnel should be notified for the next set of actions such as required maintenance to rectify problem; (viii) this will change for every industry where the system is deployed, for example, plumber, electrician, pest control, analyst/etc. is notified; (ix) an augmented reality user can visualize the area which is not covered by the automation capability, or areas where automation capabilities are down; (x) accordingly, the user can use augmented reality capabilities to select the area which are not covered by automation capabilities, and can send alternate arrangement to address the selected area; and (xi) for example, augmented reality glass has shown that a portion of the visible surrounding cannot be controlled by automation capabilities to spray water, so the user can select the area which is not covered by automation capability dispatch drone based water spraying for that selected area.

Some embodiments of the present invention may include one, or more, of the following operations, features, characteristics and/or advantages: (i) Ram is a store manager who manages a big retail store in a very busy neighborhood; (ii) the store has various IoT sensors installed and deployed for: (a) store foot-falls measurement during peak and non-peak business hours, (b) store temperature measurement at various departments (fish and meat at different temperature compared to other areas in store), (c) aisle traffic pattern detection, (d) robotic store associates serving customers and their location; (e) smart shelves identifying real time inventory updates, and (f) safety measurement measuring fire and/or customers with weird behavioral patterns; (iii) Ram wants to understand the automation capabilities of the store with multiple sensors information and determine if any area needs correction with an identified problem; and (iv) without the implementation of embodiments of the present invention: (a) observes that the number of foot-falls to store are more, (b) observe that aisle traffic is unevenly spread, (c) observing that a few store associates are answering most of the customer queries while other store associates are maneuvering purely around house-keeping, (d) observing that the inventory at certain shelves depleting at higher velocity while others are not moving at desired/expected pace, and (e) observing that most customers visiting the meat department for buying fish have done window shopping though it has not crossed shelf-life.

Some embodiments of the present invention may include one, or more, of the following operations, features, characteristics and/or advantages: (i) with implementation of embodiments of the present invention: (a) Ram wears Augmented Reality glass with required head gear to visualize, beginning at the entrance of the store, (b) the implemented embodiment enables Ram to visualize that the number of foot-falls to the store has increased and able to identify different customers with different interests, (c) visualize that arrived foot-falls are following similar patterns due to arrangement of display aisles as obtained from a planogram, (d) as a result, foot-falls traffic is not evenly distributed throughout the store, an opportunity for additional revenue, (e) visualize that a few of the store associates are answering lot of customer queries while other store associates are maneuvering purely around house-keeping matters because of their presence at wrong locations and wrong times, (f) visualize that inventory at certain shelves is getting depleted at higher velocity due to low stock replenished from back room of store and higher aisle traffic foot-fall, and (g) visualize that customers at meat department buying fish are doing window shopping primarily due to temperature variations, which is causing a perception of doubt concerning the freshness of the fish; (ii) using visualized sensor information in the AR system to determine a problem in temperature sensor, Ram is able to identify the right electrician personnel in store to attend the problem with highest priority; (iii) using the AR system to visualize which store associate to recommend as the right store associate with the right skill set at the right position to attend customers based on customer foot-falls identification for maneuvering the store associate to the right aisle for shopping; (iv) leveraging the AR system to visualize recommending inventory replenishment based on customer adding item to cart to make sure shelves are stocked with available units and not lying somewhere else in backroom of store; and (v) visualize shopper's movements inside store by changing the path with his hand to determine alternate routes for shopper and related aisle traffic patterns and associate service required.

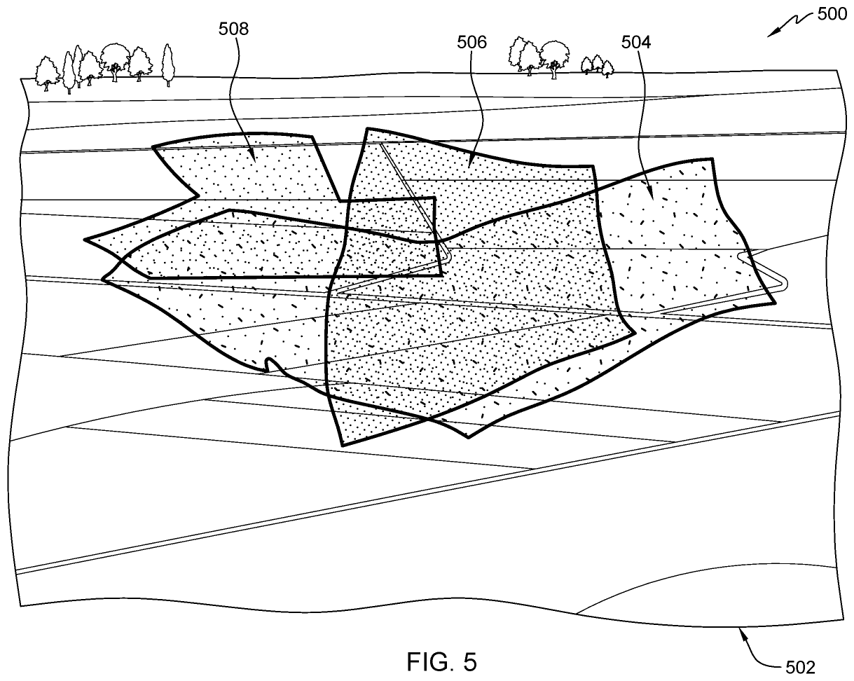

Referring to FIG. 5, some embodiments of the present invention include example visualization 500 of FIG. 5, which includes: (i) physical environment 502; (ii) automatic sprinkler based watering coverage zone 504; (iii) automatic de-weeding coverage zone 506; and (iv) automatic pesticide distribution zone 508. In FIG. 5, an Augmented reality glass is showing the IoT based Automation coverage in a physical surrounding, where the user can visualize where there is a problem with automation, workflow of automation in an animation, etc.

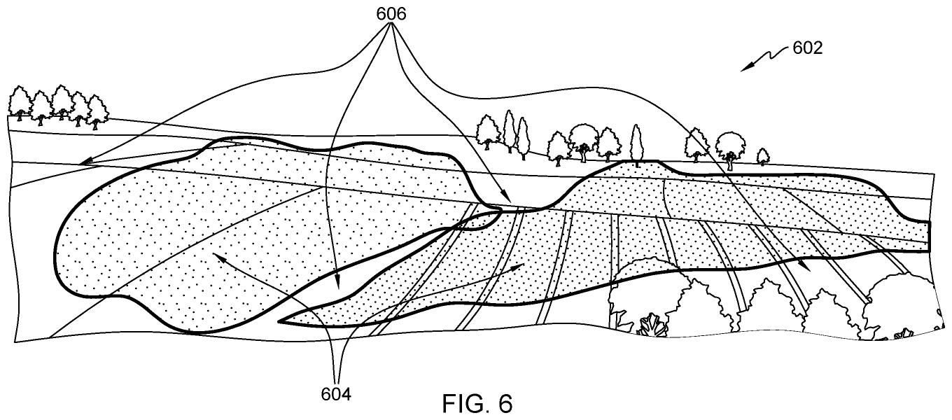

Referring to FIG. 6, some embodiments of the present invention include example visualization 600 of FIG. 6, which includes: (i) physical environment 602; (ii) automation coverage zone 604; and (iii) zone of non-automation coverage 606. In FIG. 6, a user can visualize areas of the physical environment which cannot be controlled by automation capabilities, and accordingly user can select the said areas from AR glass and deploy alternate/additional automation capability.

Some embodiments of the present invention may include one, or more, of the following operations, features, characteristics and/or advantages: (i) in any physical environment there will be different types of sensors installed, and the said sensors will be generating data automatically based on various events and time schedules; (ii) the physical environment will also have various automation capabilities, like water sprinklers and drone based pesticide distributors; (iii) automation capabilities are controlled based on the IoT feed received from the surrounding; (iv) for example, if any sensor is damaged, then moisture content around the soil area can't be measured, so automation watering will not be activated in that area; (v) every IoT sensor in any area is identified uniquely and will also identify the geolocation or relative location of the sensors in the physical environment; (vi) the IoT sensor feed will be generated on a continuous basis and sent to local a data processing unit for analysis; (vii) the analysis outcome results in activation or triggering of the automation activities; (viii) the intelligent system analyzes the IoT feed and identifies the physical area/spatial ranges where automation will be applied; (ix) the augmented reality glasses of the user will have a compass, camera, various sensors and GPS tracking installed; (x) the AR glasses also recognize the user and user roles/privileges; (xi) the augmented reality glasses identify the user's current “field of view” and accordingly calculate the distance ranges in the said physical environment with respect to user's physical position; (xii) the augmented reality system uses the camera feed to calculate distance ranges in the physical environment, the infrared or any other method can also be used to measure distance of different points in the “field of view”; (xiii) based on the user's current location and the distance of different points in the “field of view”, the augmented reality system calculates the geo-coordinate of the physical environment at different points; and (xiv) based on the geo-coordinate of different points, the augmented reality system can understand the different geo-location coordinate in the physical environment “field of view.”

Some embodiments of the present invention may include one, or more, of the following operations, features, characteristics and/or advantages: (i) the augmented reality system communicates with the local server that is controlling the automation in the said physical environment; (ii) based on the identified “field of view” of the user and geo-coordinates of different points within the “field of view”, the augmented reality system identifies the analyzed data to identify how automation coverage is possible; (iii) the augmented reality system gathers data from the local server and overlays the “field of view” of the user with automation capabilities; (iv) when the automation capabilities are overlaid over the physical environment viewing in the “field of view” of the augmented reality glass they are exactly mapped to the viewable physical environment; (v) the augmented reality system retrieves actual automation capability information from the local server and accordingly overlays the same in the “field of view” of the user; (vi) if any area is having a problem, the same will be shown in the physical environment; (vii) the augmented reality system also shows the parameters by which automation is executing, like workflow, time, or scheduling based, etc.; (viii) the augmented reality system shows the animated workflow of the automation, so the user can visualize how the automation activity is executing; (ix) the user can visualize the automation propagation using the augmented reality glass and the same will be mapped to user's “field of view”; and (x) while coverage and propagation of automation capabilities are overlaying over the “field of view” of the augmented reality glass, the user can perform finger gestures to change the propagation path, time and event scheduling, and accordingly the update will be applied in the local server.

Some embodiments of the present invention may include one, or more, of the following operations, features, characteristics and/or advantages: (i) determining automation capabilities in surrounding location when multiple sensors are deployed and determine areas of problems to notify to related personnel; (ii) achieved through AR glass models; (iii) a user with AR glass who wants to control and correct the automation, and also respects user privileges; (iv) AR is used as a tool on need basis; (v) if the capability of automation is reduced or changed, then how the automation coverage will be changed in the physical environment, and user can select the uncovered area from AR glass and execute alternate automation capability to address the problem with automation capabilities; (vi) selectively allow the user to identify the areas which are not covered by automation capabilities, and accordingly user can use alternate automation capabilities to address the problem; (vii) the method includes a step wherein, an IoT feed from any physical surrounding is analyzed to identify all possible automation capability coverages area in the visible physical surrounding; (viii) accordingly, when the user looks at that physical surrounding with augmented reality glass, then the said automation capabilities are overlaid over the “Field of View” of the user, and will exactly be mapping with physical viewable environment; (ix) the method includes a step wherein, based on the IoT feed analysis, the augmented reality system will show strength of the automation capabilities in the physical environment and also be able to view where automation capability is poor or not activated in the physical environment, which can be controlled by the user based on the privileges/roles of the user; (x) the method includes a step wherein, the Augmented Reality system shows impacted areas in any environment because of reduction or change in automation capabilities, and accordingly the user can visualize physical surrounding which will be impacted; (xi) the method includes a step wherein, if multiple automation capabilities are possible in different time frame and change in contextual situation, then augmented reality glass will be showing the time scale and contextual situation, so that user can view the automation capabilities in the time scale; (xii) the method includes a step wherein, if any automation capability propagates from one physical location to another physical location based on the time or event-based parameter, then augmented reality system will be overlaying the same in the “field of view” with animated propagation of the automation capabilities based on time or event-based criteria; (xiii) the method includes a step wherein, while interacting with augmented reality glass, user can interact with the graphical augmented reality capabilities in the surrounding and change the propagation path of automation flow with hand or finger gesture; (xiv) the method includes a step wherein, based on AR based visualization, the maintenance requirement areas are highlighted and impact analysis and if any device is having problem and will be highlighting the same in the AR system; (xv) the method includes a step wherein, based on above determination, system recommends which personnel should be notified for next set of actions on required maintenance to rectify problem; and (xvi) the method includes a step wherein, Augmented reality user can visualize the area which is not covered by the automation capability, or automation capabilities are down, and accordingly, user can use augmented reality capability to select the area which are not covered by automation capabilities, and can send alternate arrangement for address the selected area.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

In an Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, and application-specific integrated circuit (ASIC) based devices.

1. A computer-implemented method (CIM) comprising:
receiving an automation data set including information indicative of automation capability coverage in a physical space for at least one automation device;
generating a graphical representation of the automation capability coverage visualizing which portions of the physical space are covered by automation capabilities of the at least one automation device as viewed through an augmented reality (AR) device based, at least in part, on the automation data set;
displaying, on a display of the AR device, the graphical representation as an overlay upon the physical space as viewed through the AR device;
monitoring the at least one automation device for changes in automation capabilities;
responsive to changes in automation capabilities for the at least one automation device, generating an updated graphical representation visualizing which portions of the physical space are covered by the changed automation capabilities of the at least one automation device as viewed through the AR device, including portions of the physical space previously covered by the automation capabilities prior to the changes in automation capabilities; and
displaying the updated graphical representation on the display of the AR device as an overlay upon the physical space as viewed through the AR device.

2. The CIM of claim 1, further comprising:
receiving gesture based input from a user operating the AR device; and
modifying operations of the at least one automation device.

3. The CIM of claim 2, wherein modifying operations of the at least one automation device includes modifying pathing for the at least one automation device as it executes automation capabilities.

4. The CIM of claim 1, further comprising:
receiving user input corresponding to deployment of alternative automation capabilities to provide coverage to the portions of the physical space previously covered by the automation capabilities prior to the changes in automation capabilities and outside of the coverage provided by the changed automation capabilities.

5. The CIM of claim 1, wherein the graphical representation is animated to show a path of automation coverage over time, where the automation coverage changes based on a schedule.

6. The CIM of claim 1, wherein the AR device is an eyeglass-type AR wearable device.

7. A computer program product (CPP) comprising:
a machine readable storage device; and
computer code stored on the machine readable storage device, with the computer code including instructions for causing a processor(s) set to perform operations including the following:
receiving an automation data set including information indicative of automation capability coverage in a physical space for at least one automation device,
generating a graphical representation of the automation capability coverage visualizing which portions of the physical space are covered by automation capabilities of the at least one automation device as viewed through an augmented reality (AR) device based, at least in part, on the automation data set,
displaying, on a display of the AR device, the graphical representation as an overlay upon the physical space as viewed through the AR device;
monitoring the at least one automation device for changes in automation capabilities,
responsive to changes in automation capabilities for the at least one automation device, generating an updated graphical representation visualizing which portions of the physical space are covered by the changed automation capabilities of the at least one automation device as viewed through the AR device, including portions of the physical space previously covered by the automation capabilities prior to the changes in automation capabilities, and
displaying the updated graphical representation on the display of the AR device as an overlay upon the physical space as viewed through the AR device.

8. The CPP of claim 7, wherein the computer code further includes instructions for causing the processor(s) set to perform the following operations:
receiving gesture based input from a user operating the AR device; and
modifying operations of the at least one automation device.

9. The CPP of claim 8, wherein modifying operations of the at least one automation device includes modifying pathing for the at least one automation device as it executes automation capabilities.

10. The CPP of claim 7, wherein the computer code further includes instructions for causing the processor(s) set to perform the following operations:
receiving user input corresponding to deployment of alternative automation capabilities to provide coverage to the portions of the physical space previously covered by the automation capabilities prior to the changes in automation capabilities and outside of the coverage provided by the changed automation capabilities.

11. The CPP of claim 7, wherein the graphical representation is animated to show a path of automation coverage over time, where the automation coverage changes based on a schedule.

12. The CPP of claim 7, wherein the AR device is an eyeglass-type AR wearable device.

13. A computer system (CS) comprising:
a processor(s) set;
a machine readable storage device; and
computer code stored on the machine readable storage device, with the computer code including instructions for causing the processor(s) set to perform operations including the following:
receiving an automation data set including information indicative of automation capability coverage in a physical space for at least one automation device,
generating a graphical representation of the automation capability coverage visualizing which portions of the physical space are covered by automation capabilities of the at least one automation device as viewed through an augmented reality (AR) device based, at least in part, on the automation data set,
displaying, on a display of the AR device, the graphical representation as an overlay upon the physical space as viewed through the AR device;
monitoring the at least one automation device for changes in automation capabilities,
responsive to changes in automation capabilities for the at least one automation device, generating an updated graphical representation visualizing which portions of the physical space are covered by the changed automation capabilities of the at least one automation device as viewed through the AR device, including portions of the physical space previously covered by the automation capabilities prior to the changes in automation capabilities, and
displaying the updated graphical representation on the display of the AR device as an overlay upon the physical space as viewed through the AR device.

14. The CS of claim 13, wherein the computer code further includes instructions for causing the processor(s) set to perform the following operations:
receiving gesture based input from a user operating the AR device; and
modifying operations of the at least one automation device.

15. The CS of claim 14, wherein modifying operations of the at least one automation device includes modifying pathing for the at least one automation device as it executes automation capabilities.

16. The CS of claim 13, wherein the computer code further includes instructions for causing the processor(s) set to perform the following operations:
receiving user input corresponding to deployment of alternative automation capabilities to provide coverage to the portions of the physical space previously covered by the automation capabilities prior to the changes in automation capabilities and outside of the coverage provided by the changed automation capabilities.

17. The CS of claim 13, wherein the graphical representation is animated to show a path of automation coverage over time, where the automation coverage changes based on a schedule.

18. The CS of claim 13, wherein the AR device is an eyeglass-type AR wearable device.
